(19) United States
(12) Patent Application Publication
(10) Pub. No.: US 2008/0266911 A1
(43) Pub. Date: Oct. 30, 2008

(54) Current sensing circuits and methods for a converter

(75) Inventors: Mingkwang Han, Singapore (SG); Footshen Wong, Singapore (SG); Vlad Popescu, San Jose, CA (US)

Correspondence Address: O2MICRO INC;C/O MURABITO, HAO & BARNES LLP, TWO NORTH MARKET STREET, THIRD FLOOR, SAN JOSE, CA, 95113, US

(73) Assignee: O2Micro Inc

(21) Appl. No.: 12/005,732

(22) Filed: Dec. 27, 2007

Related U.S. Application Data
(60) Provisional application No. 60/927,083, filed on Apr. 30, 2007.

(51) Int. Cl. H02H 7/12

(52) U.S. Cl. 363/50

(57) ABSTRACT

In one embodiment, a current sensing circuit for a converter includes a sensing switch and a comparator. The sensing switch is coupled to a power switch within the converter for receiving a first voltage signal indicative of the current through the power switch. The sensing switch also produces a second voltage signal based on the first voltage signal. The comparator is coupled to the sensing switch for detecting an operation condition of the converter based on the second voltage signal. An offset voltage between the second voltage signal and the first voltage signal can compensate for a delay at the comparator.

### RELATED APPLICATION

This application claims priority to U.S. Provisional Application No. 60/927,083, filed on Apr. 30, 2007, the specification of which is hereby incorporated in its entirety by reference.

### BACKGROUND

1. Field

Embodiments of the present invention relate to converters.

2. Description of the Related Art

Converters are currently widely used in electronic systems for providing regulated power supplies. Typically, converters employ a structure of a switch mode power supply to achieve higher efficiency, smaller size or lighter weight. There exists a variety of converters, such as a buck converter, a boost converter, a flyback converter and a buck/boost converter. In a converter, an inductor is either connected or disconnected from a power source by switching high side and low side power switches alternately on and off. As such, the inductor acts as a reservoir of energy during every switching cycle, and energy is pulsed from the power source to a load through the inductor. Usually, to protect the converter from a variety of abnormal operation conditions, a current sensing circuit is employed to detect an operation condition of the converter. When an abnormal operation condition is identified, associated control logic can be initiated to protect the converter.

However, due to a delay at the current sensing circuit, the abnormal operation condition may not be detected fast enough. As a result, components within the converter may be damaged. In some current sensing circuits, an offset voltage is produced to compensate for such delay. However, the offset voltage typically has a random value and depends on process variation of the current sensing circuit such that the abnormal operation condition still cannot be detected fast enough.

### SUMMARY

In one embodiment, a current sensing circuit for a converter includes a sensing switch and a comparator. The sensing switch is coupled to a power switch within the converter for receiving a first voltage signal indicative of the current through the power switch. The sensing switch also produces a second voltage signal based on the first voltage signal. The comparator is coupled to the sensing switch for detecting an operation condition of the converter based on the second voltage signal. An offset voltage between the second voltage signal and the first voltage signal can compensate for a delay at the comparator.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 is a block diagram of a system with current sensing capability according to one embodiment of the present invention.

FIG. 2 is a schematic diagram of a converter circuit according to one embodiment of the present invention.

FIG. 3 is a waveform diagram of a converter circuit according to one embodiment of the present invention.

FIG. 4 is a flow chart of a method for controlling a converter according to one embodiment of the present invention.

### DETAILED DESCRIPTION

Reference will now be made in detail to embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

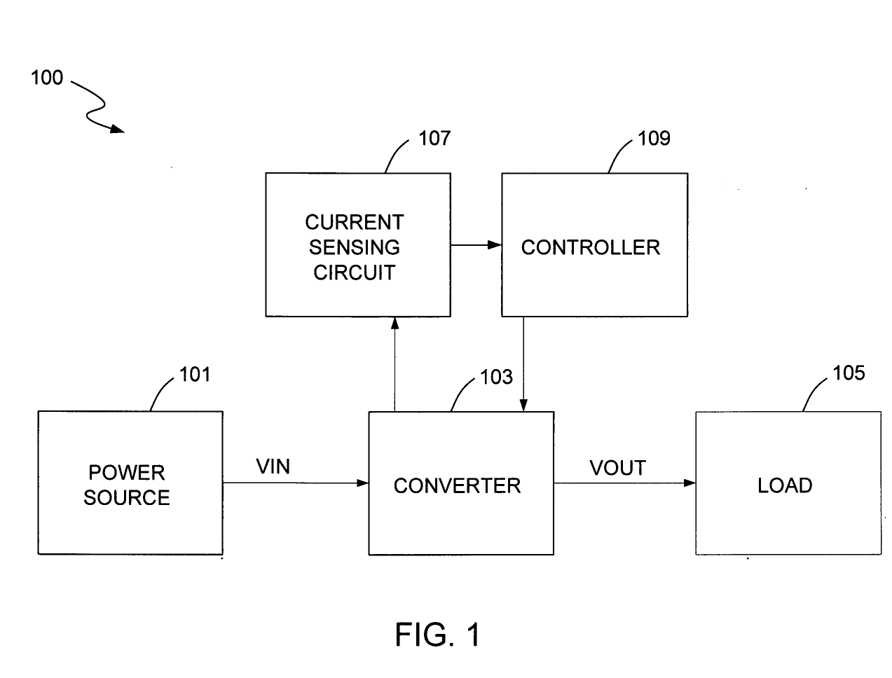

FIG. 1 illustrates a block diagram of a system 100 with current sensing capability according to one embodiment of the present invention. The system 100 functions to provide a regulated output voltage VOUT to a load 105 in a safe mode. In order to drive the load 105 properly and safely, the system 100 can include a power source 101, a converter 103, a current sensing circuit 107 and a controller 109, in one embodiment. The power source 101 provides an input voltage VIN, which is converted to the regulated output voltage VOUT by the converter 103. The controller 109 is coupled to the converter 103 to control a voltage level of the regulated output voltage VOUT. During the voltage conversion, the current sensing circuit 107 is utilized to protect the converter 103 from a variety of abnormal operation conditions. The current sensing circuit 107 can detect an operation condition of the converter 103 and instruct the controller 109 to protect the converter 103 when an abnormal operation condition is identified. Alternatively, additional protection circuitry (not shown) known to those skilled in the art can be employed in place of the controller 109 to protect the converter 103 when an abnormal operation condition is identified by the current sensing circuit 107.

Advantageously, though the current sensing circuit 107 has a delay associated with detection of operation conditions of the converter 103, a specified offset voltage can be produced to compensate for the delay. Furthermore, by sensing a current through a power switch within the converter 103 and by matching the offset voltage to the current through the power switch, the offset voltage can be adjusted to compensate for arbitrary delay associated with detection of operation conditions of the converter 103, which will be described in detail in the following sections. As such, the abnormal conditions can be detected fast enough to avoid potential damage to the converter 103.

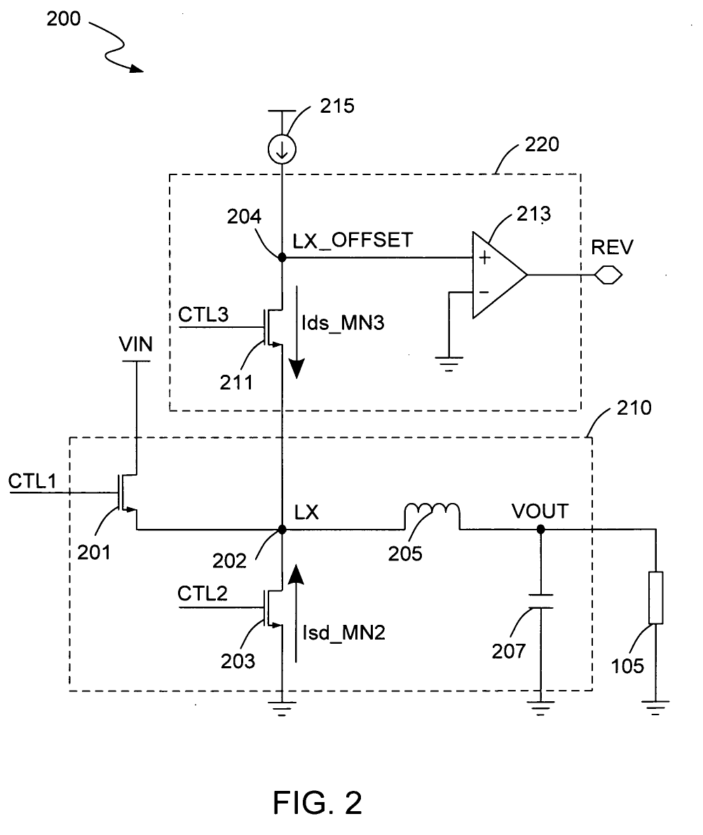

FIG. 2 illustrates a schematic diagram of a converter circuit 200 according to one embodiment of the present invention. Elements labeled the same in FIG. 1 have similar functions and will not be described herein for purposes of clarity and brevity. The converter circuit 200 includes a converter 210, a current sensing circuit 220 and a current source 215. As an example, the converter 210 includes a high side power switch 201, a low side power switch 203, an inductor 205 and a capacitor 207, and acts as a buck converter for stepping the input voltage VIN down to the output voltage VOUT. The current sensing circuit 220 includes a sensing switch 211 and a comparator 213. In one embodiment, the current source 215 can be integrated into the current sensing circuit 220.

In one embodiment, the high side and low side power switches 201 and 203 can be metal oxide semiconductor field effect transistors (MOSFETs) with a gate terminal, a source terminal and a drain terminal. The drain terminal of the high side power switch 201 is coupled to the input voltage VIN. The source terminal of the high side power switch 201 is coupled to the drain terminal of the low side switch power 203 at a node LX 202. The source terminal of the low side power switch 203 is coupled to ground. The gate terminals of the high side and low side power switches 201 and 203 receive control signals CTL1 and CTL2, respectively. In one embodiment, the control signals CTL1 and CTL2 can be pulse width modulated (PWM) signals provided by the controller 109 in FIG. 1. The LX node 202 is further coupled to the capacitor 207 through the inductor 205. The output voltage VOUT is produced at the capacitor 207. During an ON cycle of the converter 210, the high side power switch 201 is turned on while the low side power switch 203 is turned off. In this instance, the LX node 202 is electrically coupled to the input voltage VIN. As such, the inductor current rises linearly and flows in a positive direction towards the load 105. During an OFF cycle of the converter 210, the high side power switch 201 is turned off while the low side power switch 203 is turned on. In this instance, the LX node 202 is disconnected from the input voltage VIN and the inductor current will ramp down. However, the inductor current in the OFF cycle maintains the same direction as in the ON cycle, resulting in a negative voltage at the LX node 202 with respect to ground.

In normal operation conditions, the OFF cycle will be switched to the ON cycle before the inductor current ramps down to zero. However, in some instances (e.g., the load current reduces below a ripple level of the inductor current), the inductor current will flow in a negative direction. Such a reverse current condition, if not detected and compensated for as described below, could lead to power loss and also could impose high stresses on components within the converter 210, possibly damaging those components.

Advantageously, the reverse current condition can be detected by the current sensing circuit 220 fast enough to avoid these problems. To this end, the sensing switch 211 is coupled to the low side power switch 203 at the LX node 202 for receiving a voltage V_LX at the LX node 202, thereby sensing a current flowing through the low side power switch 203. The voltage V_LX at the LX node 202 is indicative of the current flowing through the low side power switch 203. The comparator 213 is coupled to the sensing switch 211 at a LX_OFFSET node 204 for comparing a voltage V_LX_OFFSET at the LX_OFFSET node 204 with zero (ground). Due to an offset voltage V_OFFSET between the voltage V_LX_OFFSET and the voltage V_LX, when the voltage V_LX_OFFSET becomes zero, the voltage V_LX still has a negative value with respect to ground. The negative value indicates that the current flowing through the low side power switch 203 is still in the positive direction. Furthermore, when the voltage V_LX_OFFSET becomes zero, the comparator 213 will be triggered to report the reverse current condition by reversing an output REV of the comparator 213. The comparator 213 has a delay associated with reporting the reverse current condition. As such, though triggering the comparator 213 occurs before the current flowing through the low side power switch 203 reverses, reporting the reverse current condition can occur at the time when the current flowing through the low side power switch 203 ramps down close to zero, e.g., 0.01 mA, by compensating the delay of the comparator 213 with the offset voltage V_OFFSET matched to 0.01 mA.

In order to compensate the delay of the comparator 213 with the offset voltage V_OFFSET, a reference current IREF is provided to flow through the sensing switch 211. In one embodiment, the current source 215 is coupled to the sensing switch 211 at the LX_OFFSET node 204 for providing the reference current IREF. The sensing switch 211 can be a MOSFET with a gate terminal, a source terminal and a drain terminal, in one embodiment. The source terminal is coupled to the LX node 202, the drain terminal is coupled to the LX_OFFSET node 204, and the gate terminal is coupled to a control signal CTL3, which controls a conduction status of the sensing switch 211. In one embodiment, the control signal can be provided by the controller 109 in FIG. 1.

As discussed above, the inductor current in the OFF cycle maintains the same direction as in the ON cycle in normal operation conditions, resulting in a negative voltage at the LX node 202 with respect to ground. Since the source terminal of the low side power switch 203 is coupled to ground, the voltage V_LX at the LX node 202 is equal to the drain-to-source voltage Vds_MN2 of the low side power switch 203. The drain-to-source voltage Vds_MN2 (V_LX) can be given by

V_{—}LX=Vds_{—}MN2=Ids_{—}MN2*Rds_{—}MN2 1)

where Ids_MN2 is the current flowing through the low side power switch 203 from the drain terminal to the source terminal, and Rds_MN2 is the on-resistance of the low side power switch 203.

Similarly, the voltage V_LX_OFFSET at the LX_OFFSET node 204 can be given by

V_{—}LX_OFFSET=Vds_{—}MN3+V_{—}LX 2)

where Vds_MN3 is the drain-to-source voltage of the sensing switch 211. As such, the offset voltage V_OFFSET between the voltage V_LX_OFFSET and the voltage V_LX is equal to the drain-to-source voltage Vds_MN3 of the sensing switch 211, that is V_OFFSET=Vds_MN3. Furthermore, the drain-to-source voltage Vds_MN3 (the offset voltage V_OFFSET) can be given by

V_OFFSET=Vds_{—}MN3 Ids_{—}MN3*Rds_{—}MN3 3)

where Ids_MN3 is the current flowing through the sensing switch 211 from the drain terminal to the source terminal, and Rds_MN3 is the on-resistance of the sensing switch 211.

As discussed above, the current Ids_MN3 is equal to the reference current IREF. As such, the drain-to-source voltage Vds_MN3 (the offset voltage V_OFFSET) can be given by

V_OFFSET=Vds_{—}MN3=IREF*Rds_{—}MN3 4)

According to equation 4), the offset voltage V_OFFSET can be precisely controlled by regulating the reference current IREF. Moreover, the MOSFET on-resistance is a function of the physical size of the MOSFET, e.g., area. In one embodiment, the sensing switch 211 can be matched to the low side power switch 203 to achieve the on-resistance Rds_MN3 which is N times the on-resistance Rds_MN2. As such, the on-resistance Rds_MN3 is given by

Rds_{—}MN3=N*Rds_{—}MN2 5)

According to equations 1), 2), 4) and 5), the voltage V_LX_OFFSET can be given by

V_{—}LX_OFFSET=IREF*N*Rds_{—}MN2+Ids_{—}MN2*Rds_{—}MN2 6)

According to equation 6), when the current Ids_MN2 decreases to −IREF*N (IREF*N is referred to as I_limit hereinafter), the voltage V_LX_OFFSET becomes zero. The sign “−” herein indicates the direction of the current Ids_MN2 is opposite to the direction of the current IREF. As such, when the voltage V_LX_OFFSET becomes zero to trigger the comparator 213, the voltage V_LX still has a negative value, which indicates that the current flowing through the low side power switch 203 is still in the positive direction, from the source terminal to the drain terminal (Isd_MN2 as shown in FIG. 2). In other words, due to the offset voltage V_OFFSET, the comparator 213 is triggered before the reverse current condition occurs. The time period ahead is controlled by the offset voltage V_OFFSET given by equation 4). Furthermore, according to the equation 4), the offset voltage V_OFFSET can have a specified value to compensate for the delay of the comparator 213, and the specified value can be maintained stable regardless of the process variation of the current sensing circuit 220. Additionally, the output REV can be readily used by additional circuitry (e.g., an additional protection circuit or the controller 109) known to those skilled in the art for protecting the converter 210.

In operation, if the delay of the comparator 213 is relatively long, the offset voltage V_OFFSET can be increased to compensate for the long delay by increasing the reference current IREF. With the increased reference current IREF, the current I_limit (N*IREF) flowing through the low side power switch 203 is also increased when the comparator 213 is triggered. In other words, the time period ahead of the reverse current condition is increased to compensate for the long delay. Similarly, if the delay at the comparator 213 is relatively short, the offset voltage V_OFFSET can be decreased to compensate for the short delay by decreasing the reference current IREF. As such, the offset voltage V_OFFSET is matched to the current through the low side power switch 203 by regulating the reference current IREF to compensate for arbitrary delay of the comparator 213.

In addition to detecting the reverse current condition, the current sensing circuit 210 is readily applicable to detect other abnormal operation conditions known to those skilled in the art, e.g., a limit current condition, which is detected by sensing a limit current flowing through the high side power switch 201. Furthermore, in addition to being applied to the converter 210 (by way of example), the current sensing circuit 210 is readily applicable to other suitable apparatuses which require accurate detection of abnormal operation conditions.

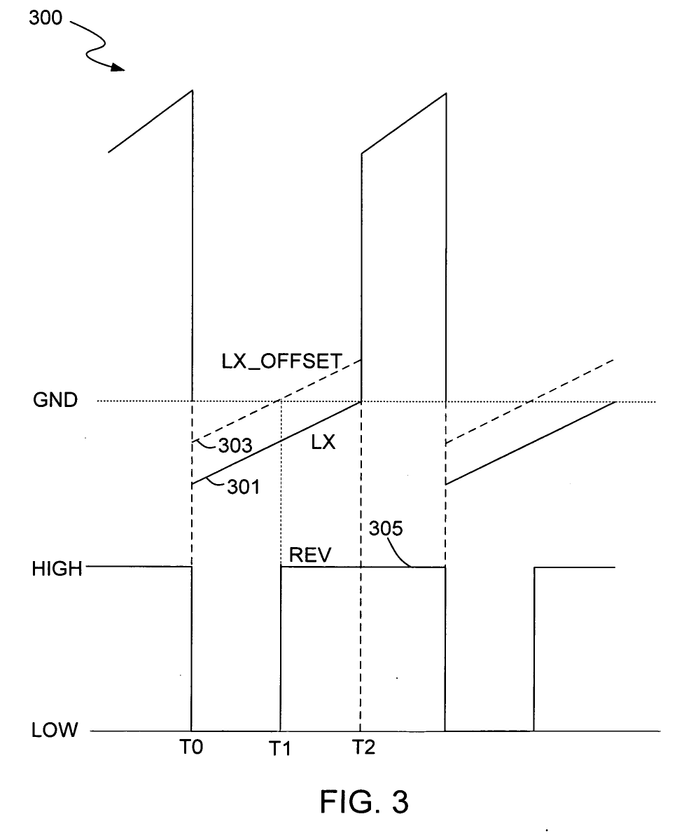

FIG. 3 illustrates a waveform diagram 300 of a converter circuit according to one embodiment of the present invention. FIG. 3 is described in combination with FIG. 2. A waveform 301 illustrates the voltage V_LX at the LX node 202. A waveform 303 illustrates the voltage V_LX_OFFSET at the LX_OFFSET node 204. A waveform 305 illustrates the output REV of the comparator 213. In order to better understand a timing sequence of the converter circuit 200, the waveform 305 is represented by way of assumption that the comparator 213 has no delay. As shown in FIG. 3, at time T0, the OFF cycle of the converter 210 starts and the voltage V_LX at the LX node 202 (shown as waveform 301) drops below ground in order to maintain the same direction of the inductor current as in the ON cycle. Dictated by the offset voltage V_OFFSET between the voltage V_LX_OFFSET and the voltage V_LX, the voltage V_LX_OFFSET at the LX_OFFSET node 204 (shown as waveform 303) also drops below ground. Since the voltage V_LX_OFFSET crosses zero (GND), the comparator 213 is triggered to change the output REV from high to low. At time T1 when the current Isd_MN2 through the low side power switch 203 ramps down to I_limit, the voltage V_LX_OFFSET at the LX_OFFSET node 204 becomes zero and therefore the comparator 213 is triggered to change the output REV from low to high by the zero crossing voltage V_LX_OFFSET. Due to the offset voltage V_OFFSET between the voltage V_LX and the voltage V_LX_OFFSET, the voltage V_LX at the LX node 202 is still below zero and the current Isd_MN2 hasn't ramp down to zero at time T1. The OFF cycle of the converter 210 proceeds until the ON cycle of the converter 210 is triggered again at time T2.

In operation, due to the delay of the comparator 213, the output REV will change from low to high at a time behind time T1. Advantageously, the comparator 213 can change from low to high at a time close to T2 (or precisely at time T2 in ideal instances) so as to report the reverse current condition fast enough.

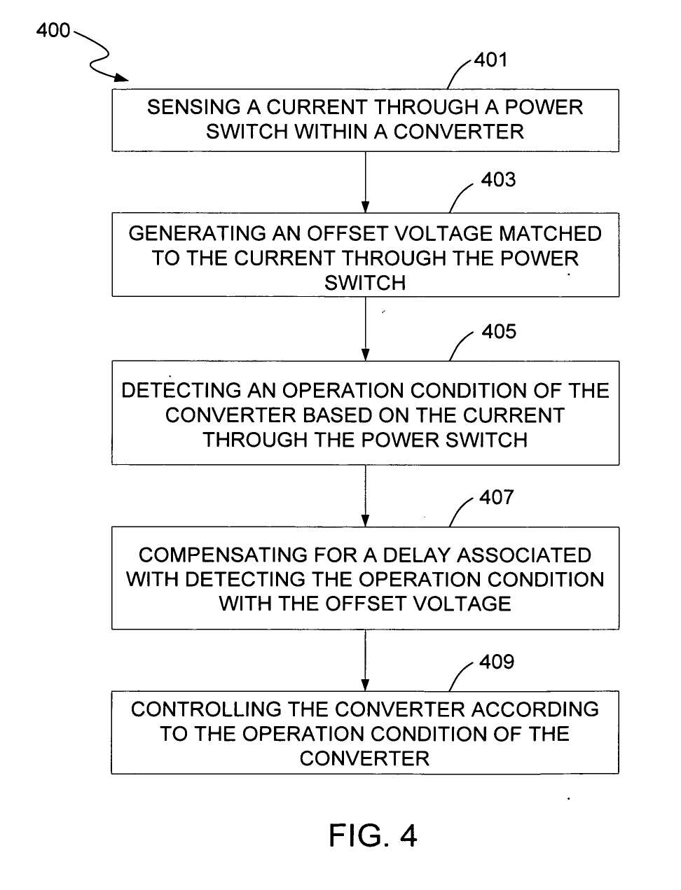

FIG. 4 is a flow chart 400 of a method for controlling a converter according to one embodiment of the present invention. FIG. 4 is described in combination with FIG. 2. Although specific steps are disclosed in FIG. 4, such steps are exemplary. That is, the present invention is well suited to performing various other steps or variations of the steps recited in FIG. 4.

In block 410, a current through a power switch within a converter is sensed. For example, the sensing switch 211 can sense the current through the low side power switch 203 within the converter 210 by receiving the voltage V_LX indicative of the current.

In block 420, an offset voltage matched to the current through the power switch is produced at a sensing switch. In one embodiment, the offset voltage V_OFFSET between the voltage V_LX and the voltage V_LX_OFFSET is produced at the sensing switch 211. The offset voltage V_OFFSET is matched to the current through the low side power switch 203.

In block 430, an operation condition of the converter is detected based on the current through the power switch. In one embodiment, the current sensing circuit 220 senses the current through the low side power switch 203, thereby detecting the operation condition of the converter 210 (e.g., the limit current condition or the reverse current condition).

In block 440, a delay associated with detecting the operation condition is compensated with the offset voltage. In one embodiment, the offset voltage V_OFFSET can accurately compensate for the delay associated with detecting the operation condition of the converter 210, thereby to report an abnormal operation condition (e.g., a reverse current condition) at the time when the current through the low side power switch 203 ramps down close to zero, e.g., 0.01 mA.

In block 450, the converter is controlled according to the operation condition of the converter. In one embodiment, the controller 109 or additional protection circuit (not shown) can take control of the converter 210 if the abnormal operation condition (e.g., the reverse current condition) is identified.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

What is claimed is:

1. A current sensing circuit for a converter, comprising:
a sensing switch coupled to a power switch within said converter operable for receiving a first voltage signal indicative of a current through said power switch and for producing a second voltage signal based on said first voltage signal; and
a comparator coupled to said sensing switch operable for detecting an operation condition of said converter based on said second voltage signal,
wherein an offset voltage between said second voltage signal and said first voltage signal is operable to compensate for a delay at said comparator.

2. The current sensing circuit of claim 1, further comprising:
a current source coupled to said sensing switch operable for providing a reference current to produce said offset voltage.

3. The current sensing circuit of claim 2, wherein said offset voltage is adjusted by regulating said reference current according to said delay at said comparator.

4. The current sensing circuit of claim 1, wherein said operation condition of said converter comprises a condition selected from at least a limit current condition and a reverse current condition.

5. The current sensing circuit of claim 1, wherein said converter is a buck converter.

6. The current sensing circuit of claim 1, wherein said power switch is a low side power switch coupled to ground.

7. The current sensing circuit of claim 1, wherein said comparator is triggered by said second voltage signal if said current through said power switch reaches a specified current level.

8. The current sensing circuit of claim 1, wherein said sensing switch is a Metal-Oxide-Semiconductor Field-Effect Transistor (MOSFET).

9. The current sensing circuit of claim 1, wherein said offset voltage is matched to said current through said power switch.

10. A converter comprising:
a power switch;
an inductor coupled to said power switch operable for receiving an input voltage and for producing an output voltage based on said input voltage;
a controller operable for controlling said output voltage; and
a current sensing circuit operable for sensing a current through said power switch to detect an operation condition of said converter and for controlling said controller according to said operation condition of said converter,
wherein said current sensing circuit is operable for producing an offset voltage based on a reference current to compensate for a delay at said current sensing circuit, and wherein said offset voltage is adjusted by regulating said reference current according to said delay at said current sensing circuit.

11. The converter of claim 10, further comprising:
a current source coupled to said current sensing circuit operable for providing said reference current.

12. The converter of claim 10, wherein said operation condition of said converter comprises a condition selected from at least a limit current condition and a reverse current condition.

13. The converter of claim 10, wherein said converter is a buck converter.

14. The converter of claim 10, wherein said power switch is a low side power switch coupled to ground.

15. The converter of claim 10, wherein said offset voltage is matched to said current through said power switch.

16. The converter of claim 10, wherein said current sensing circuit further comprises:
a current sensing switch operable for receiving a first voltage signal indicative of said current through said power switch and for producing a second voltage signal based on said first voltage signal; and
a comparator coupled to said current sensing switch operable for detecting said operation condition of said converter based on said second voltage signal,
wherein said offset voltage is produced between said first voltage signal and said second voltage signal.

17. A system comprising:
a power source operable for providing an input voltage;
a converter operable for converting said input voltage to an output voltage;
a controller operable for controlling said output voltage of said converter;
a current sensing circuit operable for detecting an operation condition of said converter and for controlling said converter based on said operation condition,
wherein said current sensing circuit comprises a sensing switch coupled to said converter, said sensing switch operable for sensing a current through a power switch within said converter and for producing an offset voltage, wherein said offset voltage is matched to said current through said power switch and operable to compensate for an arbitrary delay associated with detecting said operation condition of said converter.

18. The system of claim 17, wherein said operation condition of said converter comprises a condition selected from at least a limit current condition and a reverse current condition.

19. The system of claim 17, wherein said power switch is a low side power switch coupled to ground.

20. The system of claim 17, further comprising:
a current source coupled to said current sensing circuit operable for providing a reference current to produce said offset voltage.

21. The system of claim 17, wherein said converter is a buck converter.

22. A method for controlling a converter, comprising:
sensing a current through a power switch within said converter;
producing an offset voltage at a sensing switch, wherein said offset voltage is matched to said current through said power switch;
detecting an operation condition of said converter based on said current through said power switch;
compensating for a delay associated with detecting said operation condition with said offset voltage; and
controlling said converter according to said operation condition of said converter.

23. The method of claim 22, further comprising:
adjusting said offset voltage according to said delay associated with detecting said operation condition.

24. The method of claim 22, further comprising:
receiving a reference current used to produce said offset voltage; and
regulating said reference current to adjust said offset voltage.

25. The method of claim 22, wherein said operation condition comprises a condition selected from at least a limit current condition and a reverse current condition.
